(19) United States
(12) Patent Application Publication
(10) Pub. No.: US 2005/0088366 A1
(43) Pub. Date: Apr. 28, 2005

(54) Headset display system

(75) Inventors: Akihisa Fujio, Kyoto-shi (JP); Ryutaro Nasu, Phoenix, AZ (US); Hisashi Amafuji, Kameoka-shi (JP)

Correspondence Address: HAUPTMAN KANESAKA BERNER;Patent Agents, LLP, Suite 310, 1700 Diagonal Road, Alexandria, VA, 22314, US

(73) Assignee: SHIMADZU CORPORATION

(21) Appl. No.: 10/961,149

(22) Filed: Oct. 12, 2004

(30) Foreign Application Priority Data
Oct. 24, 2003 (JP) 2003-364592

(51) Int. Cl. G09G 5/00

(52) U.S. Cl. 345/8

(57) ABSTRACT

A headset display system includes a computer; a signal processing device electrically connected to the computer and having a processing unit for processing an image signal output from an image signal output device; and a headset display device electrically connected to the signal processing device for displaying an image corresponding to the image signal. The signal processing device has a connecting interface for connecting the computer and a controlling unit for controlling the processing unit. The computer outputs a control signal for adjusting the image and the controlling unit adjusts the image according to the control signal.

### BACKGROUND OF THE INVENTION AND RELATED ART STATEMENT

The invention relates to a headset display system for displaying a TV image or various images of instruction on a headset display device. The headset display system is connected to a computer such as a notebook computer and a wearable computer.

In a headset display system, an image signal output device such as a computer, a picture recording device or the like outputs an image signal, and a signal process device processes the image signal for the headset display device, so that the headset display device displays an image corresponding to the processed image signal. Such an image signal output from the image signal output device has an inherent variation or a variation due to a type of image signal output device. Accordingly, the displayed image may have a displacement or a deformation of a shape and the like due to jitters. In order to solve the problem, the headset display device may be provided with a switch for adjusting the image. When the switch is operated, a control signal is output to control the signal process device, so that settings of a display position, shape and the like of the displayed image are changed to adjust the displayed image. The headset display device is provided with a function in which a content of the image control through the control signal is displayed on a screen of the headset display device (OSD; On Screen Display) when the switch is operated. The headset display device may include an automatic control circuit for adjusting an image instead of the image control function through the switch operation described above.

When the headset display device itself is provided with the switch for controlling an image, a size and weight of the headset display device increase, thereby making it difficult to move or attach the headset display device. When the headset display device is provided with the automatic control circuit for controlling an image, the device has not only an increased size and weight but also increased power consumption, thereby shortening an operable battery life. When a large capacity battery is used, a weight of the device is increased and it is difficult to control an image based on preference of a user.

In view of the above problems, the present invention has been made, and an object of the invention is to provide a headset display device having a small size and light weight.

Further objects and advantages of the invention will be apparent from the following description of the invention.

### SUMMARY OF THE INVENTION

According to the present invention, a headset display system includes a headset display device and a signal processing device having a processing unit of an image signal output from an image signal output device, so that the headset display device displays an image corresponding to the image signal processed by the signal processing device. The signal processing device includes an interface for connecting a computer and a controlling unit for controlling the processing unit. The processing unit is controlled so that the computer outputs a control signal for adjusting the image displayed on the headset display device and the controlling unit adjusts the image displayed on the headset display device according to the control signal.

According to the present invention, the image displayed on the headset display device is adjusted according to the control signal output from the computer. Accordingly, it is not necessary to provide a switch in the headset display device for controlling the image, thereby reducing a size and weight of the device.

According to the present invention, it is preferable to include a manual switch for switching transmission of the control signal between the signal processing device and the computer through the interface, thereby reducing power consumption when the image control is not carried out.

It is preferable that the signal processing device is connected to the computer through the interface by a cable including a transmission line of the control signal and a supply line of the driving power. With this structure, the computer generates drive power for the headset display device, and the drive power is supplied to the headset display device through the interface. Accordingly, the headset display device is driven by the power from the computer, and the power supply and transmission of the image control signal can be carried out through the same interface and the cable, thereby eliminating a separate power source and making the structure simple, small and light. In order to perform the power supply and the transmission of the image control signal through the same interface and the same cable, it is preferable to use an interface and cable for data communication of a serial transmission system in conformity with, for example, USB standard, IEEE1394 standard or the like.

It is preferable that the control signal is output according to an operation of an input device in the computer. Also, it is preferable that the computer is used as the image signal output device, so that image control content by the control signal can be displayed on the headset display device. Alternatively, it is preferable that the control signal can be output according to the operation of the input device in the computer, and the image control content by the control signal can be displayed on a display portion of the computer. Accordingly, based on image controlling software installed in the computer, it is possible to adjust the image so that a user can easily view the headset display device. Further, the computer functions as the image signal output device, and the image control content by the control signal is displayed on the headset display device. Accordingly, it is possible to easily adjust the image while viewing the image control content by the control signal displayed on the headset display device.

According to the present invention, it is possible to easily adjust the image displayed on the headset display device with a simple structure and low power consumption without deteriorating portability and attachability.

### BRIEF DESCRIPTION OF THE DRAWINGS

FIG. 1 is a schematic view of a headset display device according to an embodiment of the present invention; and

FIG. 2 is a block diagram for explaining a structure of the headset display device according to the embodiment of the present invention.

### DETAILED DESCRIPTION OF PREFERRED EMBODIMENTS

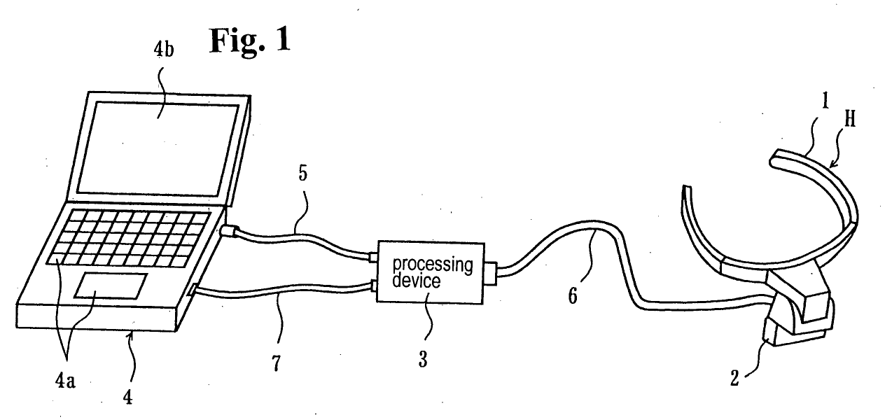

Hereunder, embodiments of the present invention will be explained with reference to the accompanying drawings. As shown in FIG. 1, a headset display device H of a headset display system includes a display unit 2 to be disposed over one of eyes of a user. The display unit 2 is attached to a holder 1 in a band shape to be put on along both sides and front portion of a head of the user. The display unit 2 is formed of, for example, a liquid crystal display and an optical system, and the liquid crystal display irradiates image light corresponding to a display image on the user's eye through the optical system. Incidentally, shapes of the holder 1 and the display unit 2 are not specially limited. For example, the holder 1 may be formed in a helmet shape or a clip shape to be easily detachable to eyeglasses, and the display unit 2 may display an image toward both eyes. A notebook computer 4 also functioning as an image signal output device is connected to the display unit 2 through a signal processing device 3.

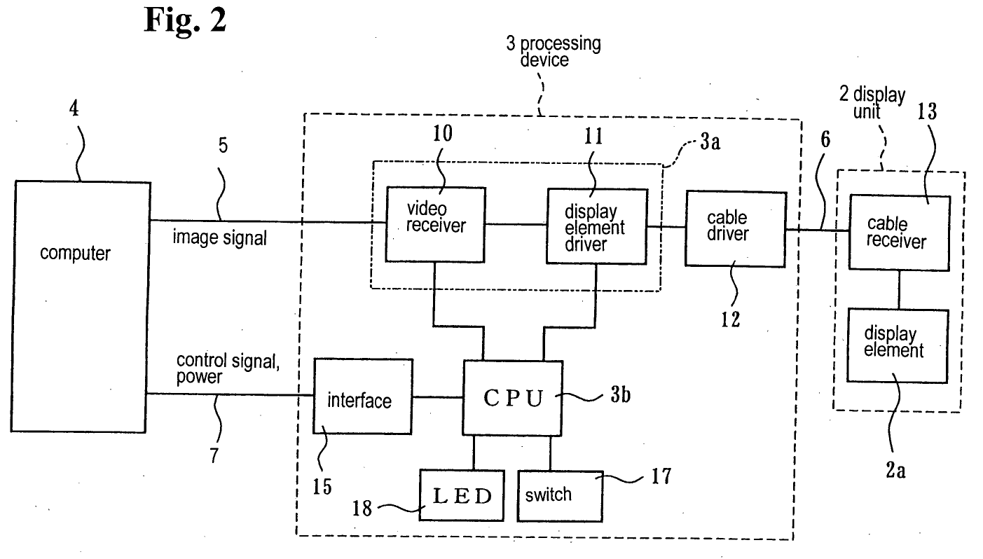

As shown in FIG. 2, the signal processing device 3 includes a processing unit 3a for processing an image signal output from the computer 4. A processing unit 3a includes a video receiver 10 to be connected to the computer 4 through a first cable 5 for transmitting the image signal. The video receiver 10 includes a computing element formed of CPU for processing the image signal controlled by a controlling unit 3b, and a memory for storing screen display data of the display unit 2. The computing element processes the image signal, and the screen display data is written in or read out of the memory. The video receiver 10 sends a signal corresponding to the screen display data, and a display element driver 11 controlled by the control portion 3b converts the signal into a driving signal of a display element 2a at the display unit 2.

The video receiver 10 and the display element driver 11 process the image signal to set a predetermined shape, display position, brightness, and contrast of an image displayed on a screen of the headset display device H. A cable driver 12 modulates a driving signal into a cable transmission signal, and the cable transmission signal is transmitted to the display unit 2 through a second cable 6. A cable receiver 13 demodulates the cable transmission signal at the display unit 2 to thereby drive the display element 2a. Accordingly, the image processed by the signal processing device 3 corresponding to the image signal is displayed on the headset display device H.

The signal processing device 3 includes an interface 15 for connecting the computer 4, and is connected to the computer 4 through a third cable 7 connected to the interface 15. The computer 4 outputs a control signal for the image displayed on the headset display device H through the third cable 7. The controlling unit 3b controls the process portion 3a according to the control signal to adjust the image displayed on the headset display device H. In other words, default settings of a shape of the image, a position of the image on the display screen, brightness of the image, contrast and the like are adjusted through the control. A manual switch 17 and a light emitting element such as a light emitting diode 18 (hereinafter referred to “LED”) are connected to the controlling unit 3b. When the switch 17 is operated, the control signal is switched on and off between the signal processing device 3 and the computer 4 through the interface 15. The light emitting element 18 is turned on when the control signal is switched on, and is turned off when the control signal is switched off.

The computer 4 has control software for adjusting the image displayed on the headset display device H, and the control signal is output through the third cable 7 according to an operation of an input device 4a such as a key board and a mouse of the computer 4. The image control content by the control signal can be displayed on the headset display device H. Accordingly, while the user with the headset display device H is viewing the image control content and the image of the image signal, the user can easily operate the input device 4a to adjust the image. Incidentally, the image control content by the control signal may be displayed on the display portion 4b of the computer 4.

The computer 4 outputs driving power for the headset display device H, and the third cable 7 includes a transmission line for the control signal and a supply line for the driving power so that the driving power is supplied to the headset display device H through the interface 15. In other words, the power supply and transmission of the image control signal can be carried out through the same interface 15 and the same cable 7. In the present embodiment, the interface 15 and the third able 7 are in conformity with the USB standard, and are not limited thereto.

In the embodiment described above, the image displayed on the headset display device H is controlled according to the control signal output from the computer 4. Accordingly, the headset display device H itself does not require a switch for controlling the image, thereby reducing a size and weight of the device. When the image control is not carried out, transmission of the control signal is switched off through the operation of the switch 17, thereby reducing the power consumption. The headset display device H is driven by the driving power output from the computer 4, and the power supply and transmission of the image control signal can be carried out through the same interface 15 and the cable 7. Accordingly, it is not necessary to provide an individual power source, thereby making the device simple, small and light.

The present invention is not limited to the embodiment described above. For example, the signal processing device 3 may be integrally connected to the headset display device H without the cable. The signal processing device 3 may include an automatic control circuit for adjusting the image. The image signal output from the computer 4 may be an analog signal or a digital signal. In a case of the analog signal, the video receiver 10 or the like of the signal processing device 3 is equipped with a function such as an AD converter. The image signal output device is not limited to the notebook computer 4. For example, the image signal output device may be a wearable computer, or an independent recording device for outputting a TV NTSC signal separately from the computer 4. In a case that the image signal output device is a single device separate from the computer 4, the image control content by the control signal is displayed on the display portion 4b.

The disclosure of Japanese Patent Application No. 2003-364592, filed on Oct. 24, 2003, is incorporated in the application.

While the invention has been explained with reference to the specific embodiments of the invention, the explanation is illustrative and the invention is limited only by the appended claims.

1. A headset display system comprising:
a computer having an image signal output device;
a signal processing device electrically connected to the computer, and including a processing unit for processing an image signal output from the image signal output device, a connecting interface for connecting to the computer, and a controlling unit connected to the interface for controlling the processing unit; and
a headset display device electrically connected to the signal processing device for displaying an image corresponding to the image signal, said headset display device being connected to the computer through the signal processing device such that the computer outputs a control signal for the image and the controlling unit adjusts the image displayed at the headset display device according to the control signal.

2. A headset display system as claimed in claim 1, wherein said signal processing device further includes a switch for switching transmission of the control signal between the signal processing device and the computer through the interface.

3. A headset display system as claimed in claim 1, further comprising a cable arranged between the computer and the interface, said computer outputting a driving power of the headset display device and said cable including a transmission line for the control signal and a supply line for providing the driving power from the computer to the headset display device through the interface.

4. A headset display system as claimed in claim 1, wherein said computer functions as the image signal output device so that the control signal is output according to an input operation of the computer and the headset display device displays content of the control signal.

5. A headset display system as claimed in claim 1, wherein said computer has an input device for outputting the control signal, and a display portion for displaying content of the control signal.

6. A headset display system as claimed in claim 3, further comprising another cable connected between the processing unit and the computer for transmitting the image signal to the processing unit.
